(19) United States
(12) Patent Application Publication
(10) Pub. No.: US 2010/0299874 A1
(43) Pub. Date: Dec. 2, 2010

(54) Sliding Hinge

(76) Inventor: Ming-Han Lin, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/472,542

(22) Filed: May 27, 2009

(51) Int. Cl. E05F 1/14

(52) U.S. Cl. 16/280

(57) ABSTRACT

A sliding hinge includes a flat base body having an opening at a middle thereof, a sliding body slidably coupled with the base body, and at least one torsion spring placed in the opening of the base body. The at least one torsion spring has a first elastic arm and a second elastic arm. A free end of the first elastic arm is pivotably connected to a middle portion of a side of the opening parallel to a sliding direction of the sliding body. A free end of the second elastic arm is pivotably connected with a middle portion of the sliding body. The torsion spring is moved in the opening to store an elastic force when the sliding body is pushed to bring the second elastic arm to approach the first elastic arm gradually, and subsequently to release the stored elastic force to make the sliding body slide automatically.

### BACKGROUND OF THE INVENTION

1.Field of the Invention

The present invention relates to a hinge, and more particularly to a sliding hinge mainly applied in a sliding type electronic device.

2. The Related Art

An electronic device, such as a cellular phone, an electronic dictionary, and the like, is designed to have two parts slidable relatively via a sliding hinge for reducing the volume and enlarging the image display area thereof. Generally, a sliding hinge 200 in prior art, shown in FIGS. 6-7, includes a base body 61, a sliding body 63 slidably coupled with the base body 61 by means of sliding elements 62 mounted therebetween and a torsion spring 64 placed between the base body 61 and the sliding body 63. The torsion spring 64 has a first elastic arm 641 and a second elastic arm 642. A free end of the first elastic arm 641 is pivotably connected to the base body 61. A free end of the second elastic arm 642 is pivotably connected to the sliding body 63. The sliding body 63 is firstly pushed to make the torsion spring 64 deform and then driven to move forwards automatically by releasing a stored elastic force of the torsion spring 64. However, since the torsion spring 64 is placed between the base body 61 and the sliding body 63, the sliding hinge 200 will result in increasing the height thereof for allowing the torsion spring 64 to move therein smoothly, which is against the current trends towards lightness, thinness, shortness and smallness of the electronic devices.

### SUMMARY OF THE INVENTION

Accordingly, an object of the present invention is to provide a sliding hinge having a thin construction. The sliding hinge includes a flat base body having an opening at a middle thereof, a sliding body slidably coupled with the base body, and at least one torsion spring placed in the opening of the base body. The at least one torsion spring has a first elastic arm and a second elastic arm. A free end of the first elastic arm is pivotably connected to a middle portion of a side of the opening parallel to a sliding direction of the sliding body. A free end of the second elastic arm is pivotably connected with a middle portion of the sliding body. The torsion spring will move in the opening to store an elastic force when the sliding body is pushed to bring the second elastic arm to approach the first elastic arm gradually, and subsequently release the stored elastic force to make the sliding body slide automatically.

As described above, either an sliding type electronic device with the sliding hinge mounted thereon is opened or closed, the torsion spring is moved in the opening to drive the sliding body to slide with respect to the base body automatically. The sliding hinge does not need to leave a relatively large space between the base body and the sliding body at a direction perpendicular to the base body, for receiving the torsion spring, which reduces the height of the sliding hinge and, consequently, reduces the thickness of the electronic device.

### BRIEF DESCRIPTION OF THE DRAWINGS

The present invention will be apparent to those skilled in the art by reading the following description, with reference to the attached drawings, in which:

FIG. 1 is an assembled, perspective view of a sliding hinge of an embodiment according to the present invention;

FIG. 2 is an assembled, perspective view of the sliding hinge shown in FIG. 1 seen from a bottom angle;

FIG. 3 is an exploded, perspective view of the sliding hinge shown in FIG. 1;

FIG. 4 is an assembled, perspective view of the sliding hinge shown in FIG. 1, wherein half of a sliding plate is removed;

FIG. 5 is a plan view showing an operation process of the sliding hinge shown in FIG. 1 from a close status to a middle status in which a torsion spring has a maximum deformation;

FIG. 6 is a perspective view of a sliding hinge according to prior art; and

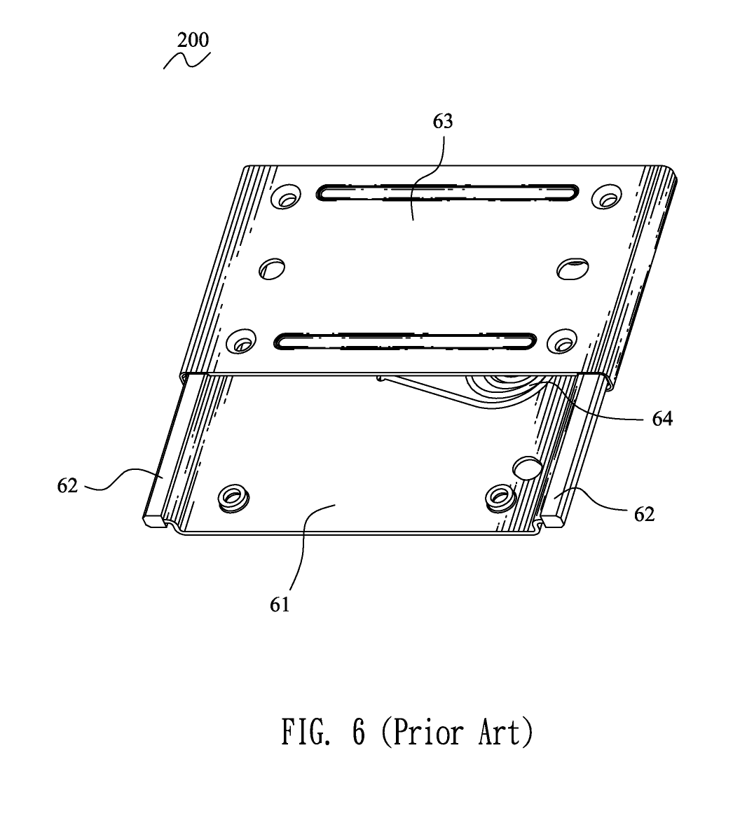

FIG. 7 is a plan perspective view showing an operation process of the sliding hinge shown in FIG. 6 from a close status to a middle status in which the torsion spring has a maximum deformation.

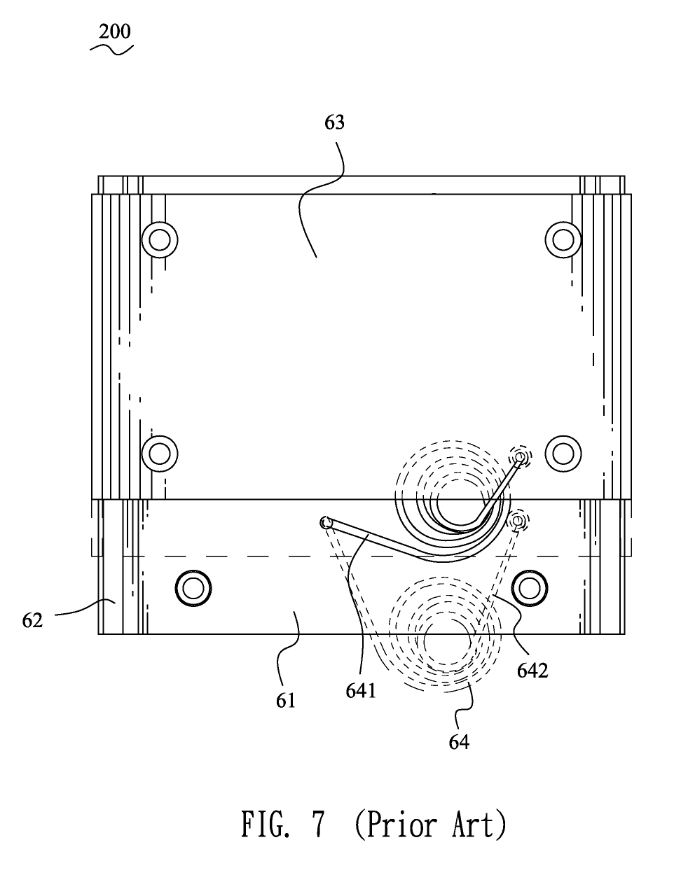

### DETAILED DESCRIPTION OF THE EMBODIMENT

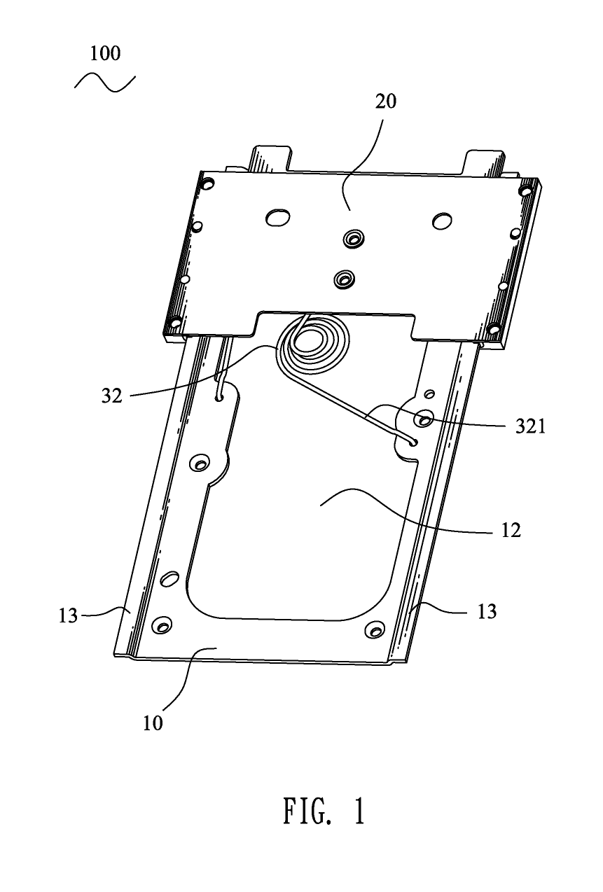

With reference to FIGS. 1-3, a sliding hinge 100 according to the present invention includes a base body 10 fixed to a lower housing of a sliding type electronic device (not shown), a sliding body 20 slidably coupled with the base body 10 and fixed to an upper housing of the sliding type electronic device, and two torsion springs 31 and 32 placed between the base body 10 and the sliding body 20.

The base body 10 has a base plate 11 of rectangular shape. The base plate 11 has a substantial rectangular opening 12 at a middle portion thereof. The opening 12 is enlarged and extended to be apart from the edges of the base plate 11 with a short distance. Two opposite long sides of the opening 12 are protruded inwards to form mounting slices 14. Each of the mounting slices 14 has a mounting hole 15. The mounting holes 15 are biased from each other. Two opposite long sides of the base plate 11 extend upwards and bend outwards to form two lateral portions 13.

The sliding body 20 has a sliding plate 21 of rectangular shape. The sliding plate 21 has two pivot holes 22 arranged at a middle portion thereof and aligned with each other along a sliding direction thereof. Two opposite short sides of the sliding plate 21, parallel to the sliding direction of the sliding body 20, respectively have two fixing holes 23 spaced away from each other.

The sliding hinge 100 further has two sliding elements 50 for slidably fixing the base body 10 and the sliding body 20 together. Each of the sliding elements 50 has a sliding rail 51 and a connecting bar 52 coupled with the sliding rail 51. The sliding rail 51 is a bar shape and has a receiving groove 511 at an inner side thereof for receiving the lateral portion 13 of the base body 10. An outer side of the sliding rail 51 is protruded outwards to form two protrusions 512 of substantially T shape, engaged with substantial T-shaped grooves 521 formed on a top of the connecting bar 52 using a press fit, for fixing the sliding rail 51 and the connecting bar 52 together. The connecting bar 52 further has two fixing lumps 522, located between the grooves 521 and adjacent to the respective grooves 521, corresponding to the fixing holes 23.

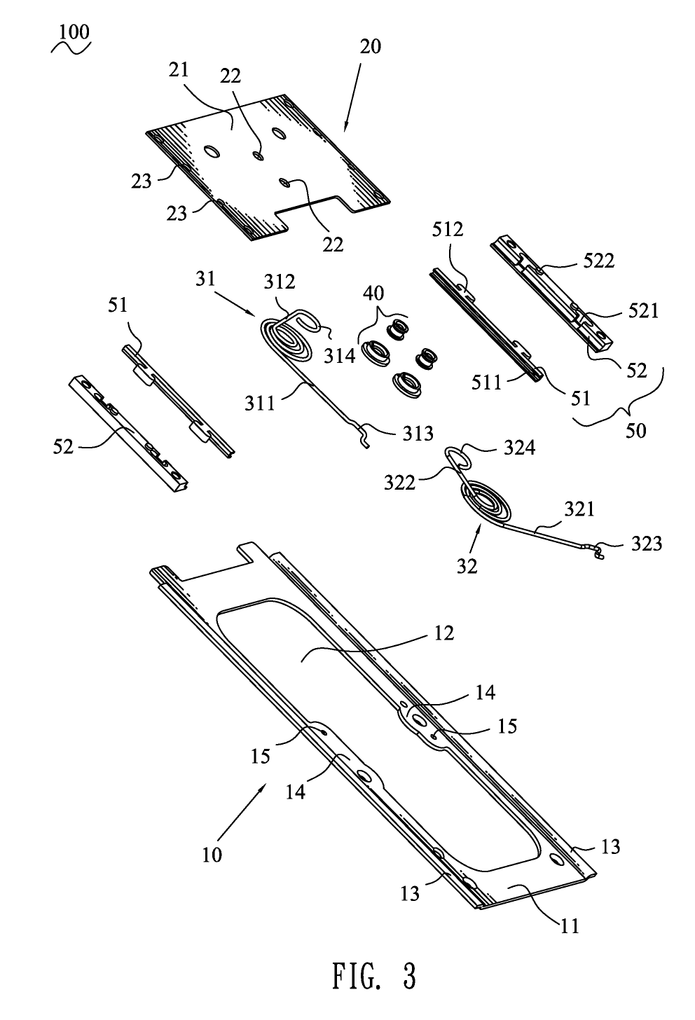

Please refer to FIG. 3, the torsion spring 31 located in the opening 12 of the base body 10 has a first elastic arm 311 and a second elastic arm 312. A free end of the first elastic arm 311 is extended downwards and bent opposite to the first elastic arm 311 to form a fixing portion 313, showing an L shape. A free end of the second elastic arm 312 is curled to form a fixing ring 314. The torsion spring 32, the same as the torsion spring 31, is also located in the opening 12 and has a first elastic arm 321, a second elastic arm 322, a fixing portion 323 and a fixing ring 314.

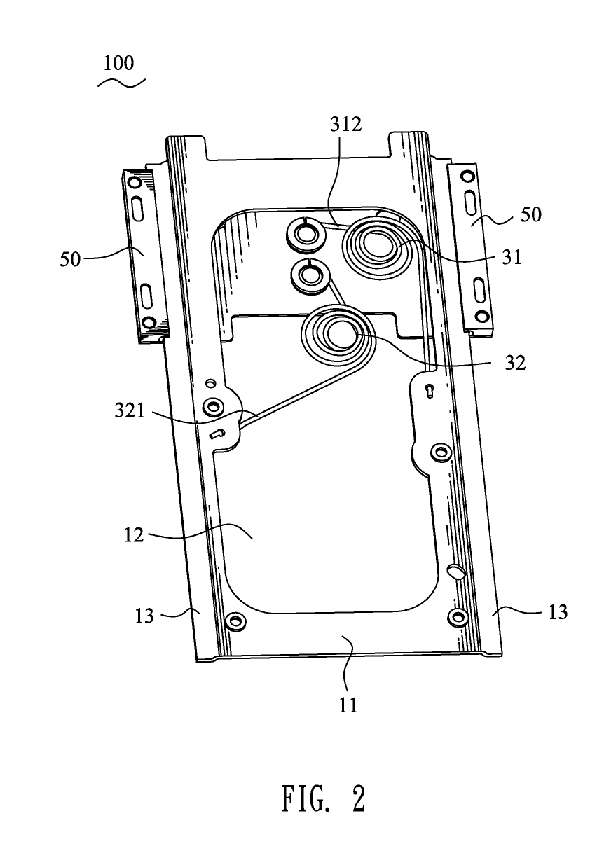

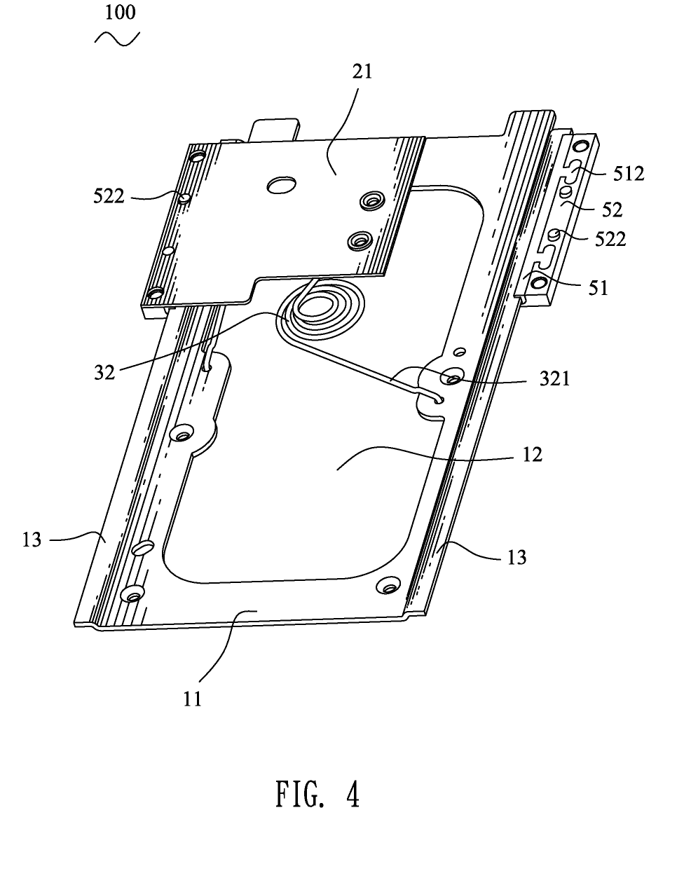

Referring to FIGS. 2-4, in assembly, the lateral portions 13 are slidably mounted in the corresponding receiving grooves 511. The sliding body 20 is fixed to the connecting bar 52 by pressing the fixing lumps 522 into the fixing holes 23. The torsion springs 31, 32 are located in the opening 12. The fixing portion 313 of the torsion spring 31 is pivoted to one of the mounting holes 15 closer to the sliding plate 21. The fixing ring 314 is pivoted to the pivot hole 22 of the sliding plate 21 farther from the mounting hole 15 by a connecting element 40. The fixing portion 323 of the torsion spring 32 is pivoted to the other mounting hole 15 farther from the sliding plate 21. The fixing ring 324 is pivoted to the other pivot hole 22 closer to the mounting hole 15 by another connecting element 40.

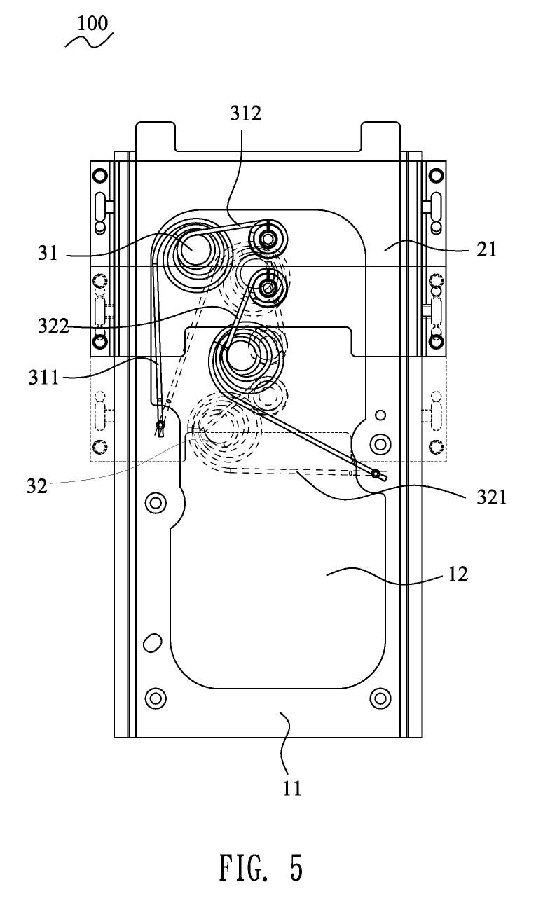

FIG. 5 is a plan view illustrating a movement process of the sliding type electronic device with the sliding hinge 100 from the close status to the middle status. As a user pushes the upper housing with respect to the lower housing to open the sliding type electronic device, a certain level of the external force is applied from the user to the upper housing and brings the sliding body 20 to slide forwardly along the lateral portions 13, which drives the torsion springs 31, 32 to move forwardly. As a result, the fixing portions 313, 323 and the fixing rings 314, 324 approach each other gradually and respectively. In this process, the stored elastic force of the torsion springs 31, 32 are accumulated gradually until reaching maximum when the first elastic arm 321 is disposed levelly or perpendicularly to the sliding direction of the sliding body 20. At this time, although the user does not push the upper housing, the fixing rings 314, 324 continue moving forward away from the fixing portions 313, 323 gradually as the stored elastic force of the torsion springs 31, 32 releases. Thus the sliding type electronic device can be opened semi-automatically. The closed process of the sliding type electronic device with the sliding hinge 100 is operated substantially the same as described above.

As described above, either the sliding type electronic device is opened or closed, the torsion springs 31, 32 are moved in the opening 12 to drive the sliding body 20 to slide with respect to the base body 10 automatically. The sliding hinge 100 does not need to leave a relatively large space between the base body 10 and the sliding body 20 along a direction perpendicular to the base body 10, for receiving the torsion springs 31 and 32, which reduces the height of the sliding hinge 100 and, consequently, reduces the thickness of the electronic device. In addition, the sliding hinge 100 are provided with the torsion springs 31 and 32 to achieve the semi-automatic open or close function, which will keep better pushing force and prolong the using time.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A sliding hinge, comprising:
a flat base body having an opening at a middle thereof,
a sliding body slidably coupled with the base body; and
at least one torsion spring placed in the opening of the base body, the at least one torsion spring having a first elastic arm and a second elastic arm, a free end of the first elastic arm being pivotably connected to a middle portion of a side of the opening parallel to a sliding direction of the sliding body, a free end of the second elastic arm being pivotably connected with a middle portion of the sliding body,
wherein the torsion spring is moved in the opening to store an elastic force when the sliding body is pushed to bring the second elastic arm to approach the first elastic arm gradually, and subsequently to release the stored elastic force to make the sliding body slide automatically.

2. The sliding hinge as claimed in claim 1, wherein there are two analogue torsion springs located in the opening, middles of two opposite sides of the rectangular opening are protruded inwards to form mounting slices, each of the mounting slices is formed with a mounting hole for pivoting the first elastic arm.

3. The sliding hinge as claimed in claim 2, wherein the mounting holes are biased from each other, the sliding body has two pivot holes aligned with each other along the sliding direction of the sliding body for connecting with the corresponding second elastic arms of the torsion springs.

4. The sliding hinge as claimed in claim 1, further comprising a pair of sliding elements, the sliding element having a sliding rail slidably mounted to a side of the base body, and a connecting bar engaged with the sliding rail and fixed to a corresponding side of the sliding body.

5. The sliding hinge as claimed in claim 4, wherein the sliding rail has a plurality of T-shaped protrusions at an outer surface thereof opposite to the base body, the protrusions are engaged with corresponding T-shaped grooves formed at a top of the connecting bar for fixing the sliding rail and the connecting bar together.

6. The sliding hinge as claimed in claim 4, wherein a top of the connecting bar is protruded upwards to form a plurality of fixing lumps for pressing in fixing holes formed on the sliding body.
